(19) United States
(12) Patent Application Publication
(10) Pub. No.: US 2008/0105468 A1
(43) Pub. Date: May 8, 2008

(54) Method for Checking Capsules

(76) Inventors: Pierantonio Ragazzini, Foril (IT); Giorgio Tarozzi, Nonantola (IT)

Correspondence Address: NIXON & VANDERHYE, PC, 901 NORTH GLEBE ROAD, 11TH FLOOR, ARLINGTON, VA, 22203, US

(21) Appl. No.: 11/664,123

(22) PCT Filed: Sep. 27, 2005
(86) PCT No.: PCT/EP05/10414

§ 371 Date: Mar. 30, 2007

(30) Foreign Application Priority Data
Sep. 30, 2004 (IT) B02004A000601

(51) Int. Cl. G01G 9/00; G01G 19/00

(52) U.S. Cl. 177/1; 177/25.12

(57) ABSTRACT

A method for checking capsules comprises in sequence the phases of weighing each empty capsule and associating the related empty weight value with said capsule by applying a related identification code to the capsule; filling the capsules with doses of filling material, preferably pharmaceutical material; weighing each capsule filled with said material to obtain a related weight value of the filled closed capsule and interpreting the identification code carried by said capsule and relating to its empty weight value; and comparing the weight value of the filled capsule with the empty weight value carried by the aforementioned code in order to detect and check the correctness of the dosage of the material inside each capsule.

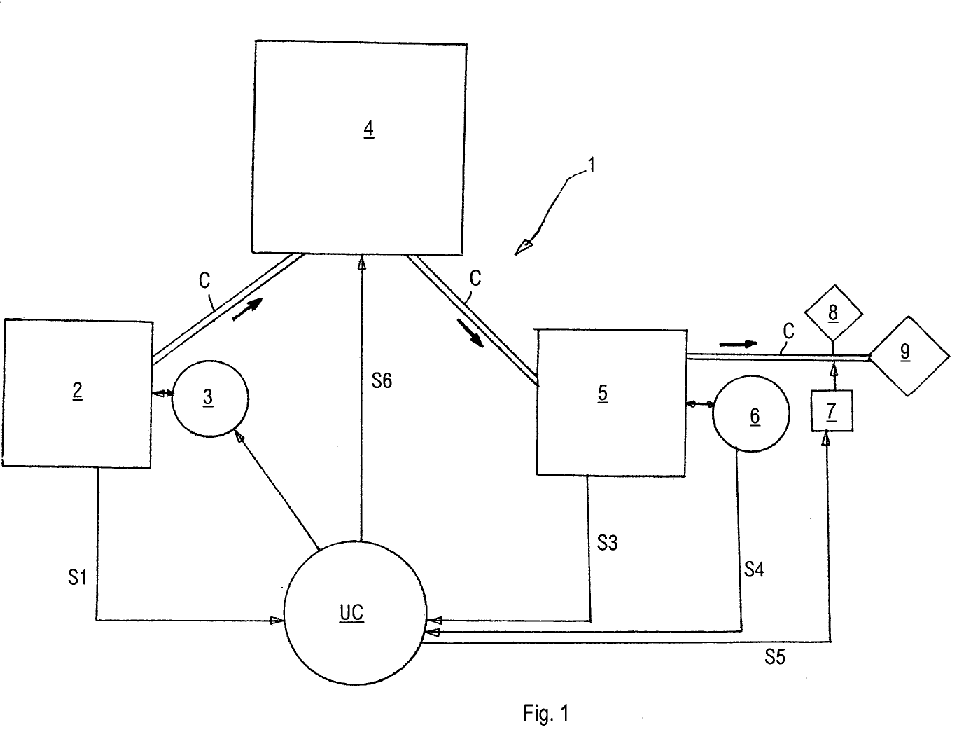

The present invention relates to a method for checking capsules.

In particular, the present invention is used for manufacturing hard gelatine capsules of the cap-body type with weight control and in particular for checking their dosage with pharmaceutical material in powder or solid form, such as tablets, microtablets or delayed-action tablets and the like, or in liquid form, to which the following disclosure will explicitly refer without thereby losing general relevance.

In general, the manufacturing of hard gelatine capsules of the cap-body type, filled with pharmaceutical material occurs through the use of automatic capsule filling machines of the type with a rotating turret, which operate according to a sequence of main operating phases that successively provide an opening phase of the individual closed capsules, in a separating station of the caps from the corresponding bodies, in order to form two relative sequences of caps and bodies that are separated from one another; at a dosing station, the dosage of each body with a quantity or dose of pharmaceutical material; and a closing phase of the filled capsule by applying the corresponding cap onto the body. Once the closing phase has been completed, the capsules are then supplied out of the capsule filling machine and are collected in an suitable container.

In order to detect and check the weight of the capsules thereby produced, weighing devices are currently known that are generally arranged downstream of the capsule filling machines and to which the filled and closed capsules are supplied in succession by the capsule filling machines by means of suitable transfer conveyors.

From U.S. Pat. No. 5,796,051, for example, a capsule weighing apparatus is known that substantially comprises a endless belt conveyor wrapped around horizontal-axis pulleys and on which an equally distributed series of hollow seats is fitted, each one of which is suitable for receiving a corresponding capsule in a horizontal extended position.

During the advance of the belt conveyor, the seats traverse a weighing station defined by a series of load cells arranged below the conveyor, causing in this way the contact between the load cells and the capsules which therefore are weighed.

According to the operating method obtained by using this weighing apparatus, once the value corresponding to the weight of each filled and closed capsule has been detected, this value is compared with a reference value. If significant variances from the reference value are detected, which are however outside preset ranges, the apparatus is able to subsequently reject the corresponding capsule, sending it to a rejects container arranged downstream of said weighing station along the conveyor.

Said weighing apparatus nevertheless has significant drawbacks that are not only structural, due to the complexity of its components, but above all due to its effectiveness in calculating the weight of the capsules.

In fact, with the aforementioned weighing apparatus it is impossible to detect whether in defective capsules the error is due to weight irregularities of the cap and/or the body of hard gelatine defining each capsule, or is due to incorrect dosage of the pharmaceutical material inside the capsule, or again is due to both reasons.

On the other hand, neither is the apparatus able to detect whether in a acceptable detected capsule any insufficiency of dosage pharmaceutical material is compensated by a greater cap and/or body weight that defines the capsule with respect to the caps and/or bodies constituting the other capsules.

Substantially, with the aforementioned weighing apparatus it is not possible to obtain precise information concerning the correctness of the dosage of the capsules with the pharmaceutical material.

The object of the present invention is to provide a method for checking capsules using which it is possible to overcome the aforementioned drawback.

In particular, the object of the present invention is to provide a simple and rapid method for detecting and checking the correct and effective dosage of the capsules with the filling material.

According to the present invention a method is provided for checking capsules, preferably pharmaceutical capsules, characterised in that it comprises in sequence the phases of weighing each empty capsule and associating the empty weight value with said capsule by applying on said capsule a corresponding identification code; dosing filling material inside the capsules; weighing each capsule filled with said material to obtain a corresponding weight value of the filled closed capsule and interpreting said identification code carried by the capsule and relating to the value of its empty weight value; and comparing the weight value of the filled capsule with the empty weight value carried by said code in order to detect and check the dosage of the material inside each capsule.

The technical features of the invention according to the aforementioned objects are clearly disclosed in the following claims and the advantages of the invention will become clearer in the following detailed disclosure which refers to the attached figure in which, according to a block diagram, it is shown a preferred but not limitative embodiment of a plant for manufacturing capsules with weight control which implement the method of the invention.

With reference to the attached FIGURE, 1 generally indicates a plant with weight control or checkweighing for manufacturing capsules of hard gelatine of the known cap-body type (and therefore not shown) used preferably in the pharmaceutical field.

The plant 1 comprises a weighing apparatus 2 fit for detecting and checking the effective weight of each “empty closed capsule”, in which “empty closed capsule” refers to an assembly formed of a hard gelatine cap superimposed on a relative body, also in hard gelatine.

Preferably, but not exclusively, the apparatus 2 is of the type disclosed and protected in European Patent EP 886765B1 of the same applicant (to the disclosure and drawings of which the reader is referred, without entering into details), which apparatus substantially comprises a drum with suction seats that picks up the empty capsules from a hopper and supplies them in succession to a series of weighing stations, each of which is defined by transducers, preferably load cells scales, arranged in series and on which the capsules are positioned to be weighed.

According to what has been illustrated in the attached FIGURE, the operating method of the present invention provides for the weight value of each empty closed capsule detected by a related scales of the apparatus 2 being sent by a corresponding signal S1 to a central unit UC, which simultaneously actuates an encoding device 3 by a signal S2.

According to the objects of the present invention, the device 3 is applied and fitted inside the apparatus 2 (although for the sake of descriptive simplicity in the block diagram of the attached FIGURE it is shown applied outside the apparatus 2) and is suitable for associating with the empty capsule an identification code of its weight immediately before the capsule leaves the weighing station.

Specifically, the encoding device 3 is suitable for applying, that is impressing on a small portion of the empty capsule (for example on a small portion of the external convex surface of the cap or the body) an identification microcode which identifies the empty capsule weight: preferably, but not exclusively, the microcode that is applied to each capsule is of the known type, such as barcode or similar code. In this way, at the outlet of apparatus 2, which supports the device 3, each empty capsule is provided with an identification microcode of its weight.

Downstream of the apparatus 2 and therefore of the device 3, the plant 1 comprises a capsule filling machine 4 to which the empty capsules are supplied by known conveying means.

The capsule filling machine 4 is of the type with a known structure and is suitable for executing in sequence, according to an operating method which is also known, an opening phase in a separating station of the caps from the corresponding bodies, of the single empty closed capsules to form two related sequences of caps and bodies separated from one another; a filling phase at a dosing station for filling each body with a quantity or dose of pharmaceutical material; and a closing phase of the filled capsule by applying the related cap onto the body.

At the end of the closing phase, the “filled closed capsules”, i.e. the bodies filled with pharmaceutical material and closed with their respective caps, are supplied out of the capsule filling machine 4 to a further weighing apparatus 5 by means of known conveying means C.

The weighing apparatus 5 is of the same type and structure as the apparatus 2, and is suitable for detecting and checking the weight of each filled closed capsule manufactured by the capsule filling machine 4 and for sending a related signal S3 to the UC control unit in order to store the information relating to the weight value carried by the signal S3.

Similarly to the device 3 supported by the apparatus 2 at the weighing-scale stations, said apparatus 5 has a code-reading device 6 inside (although for the sake of illustrative simplicity in the block diagram of the attached figures it has been shown applied to the outside of the apparatus 5), which is suitable, for each filled closed capsule positioned at the related scales, for interpreting, that is reading, the code carried or impressed on the external portion of the capsule relating to its “empty” weight and carried out by the device 2, and for sending a corresponding signal S4 to the UC unit.

The UC unit is thus able to compare the two signals S3 and S4, specifically relating to the “gross” weight of the filled capsule and to the “empty” weight of the empty capsule respectively, namely the tare weight. Therefore, by the difference of the values carried by the signals S3 and S4, the UC unit is able to precisely detect the value of the effective dosage of the pharmaceutical material inside the capsule.

Once this checking phase has finished, the capsules are then supplied by suitable conveying means C out of the apparatus 5 to a collection container 9 or to packaging machines such as for example blister machines or filling/counting machines.

If the UC unit detects that the value relating the capsule filling, namely the effective dosage, is incorrect or deviates considerably from a preset reference value or however is out of preset tolerance value ranges, said UC unit is able to activate, by a signal S5, a reject unit 7 in such a way as to reject the defective capsule into a reject container 8 arranged along the conveying means C.

When a plurality of capsules are defective, the UC unit is furthermore able to send a signal S6 to the capsule filling machine 4, in particular to its dosing station, so as to intervene to restore the correct dosing parameters of the pharmaceutical material inside the bodies that may have been erroneously modified during the production.

Lastly, it should be underlined that the method of the present invention and the application of the code to each capsule makes possible the precise, rapid and effective check of the effective dosage of the pharmaceutical material inside the capsules. This is also achieved operating at high production speeds.

1-3. (canceled)

4. Method for checking capsules, for example pharmaceutical capsules, the method comprising in sequence the phases of weighing each empty capsule and associating the related empty weight value with said capsule by applying a related identification code on said capsule; dosing filling material inside said capsules; weighing each capsule filled with said material to obtain a related weight value of the filled closed capsule and interpreting said identification code carried by said capsule and relating to its empty weight value; and comparing said weight value of the filled capsule with said empty weight value carried by the aforementioned code in order to detect and check the dosage of said material inside each capsule.

5. Method according to claim 4, wherein said identification code is applied to the external surface of said capsule.

6. Method according to claim 4, wherein said identification code is a barcode.

7. Method according to claim 5, wherein said identification code is a barcode.
